(19) United States
(12) Patent Application Publication
(10) Pub. No.: US 2017/0051474 A1
(43) Pub. Date: Feb. 23, 2017

(54) PATH DETECTION FOR GROUND ENGAGING TEETH

(71) Applicant: Caterpillar Inc., Peoria, IL (US)

(72) Inventors: Nolan Finch, Champaign, IL (US); Venkata Bhagavathi Dandibhotla, Peoria, IL (US); Anish Shenoy, Champaign, IL (US)

(73) Assignee: Caterpillar Inc., Peoria, IL (US)

(21) Appl. No.: 15/343,428

(22) Filed: Nov. 4, 2016

(51) Int. Cl. E02F 9/26; G06T 7/20; G06T 7/00; E02F 9/28

(52) U.S. Cl. CPC E02F 9/26; E02F 9/2808; G06T 7/204; G06T 7/001; G06T 7/0008; E02F 3/3417

(57) ABSTRACT

A method for path detection associated with ground engaging teeth of an implement is the provided. The method includes receiving, by a controller, an image feed of a dump operation being performed by the implement. The method includes detecting the ground engaging teeth in each of the plurality of frames. The method includes analyzing a path traced by the ground engaging teeth over the plurality of frames. The method includes determining the path traced by the ground engaging teeth based on aggregated path information. The method includes comparing the determined path traced by the ground engaging teeth with a pre-determined path. The method includes identifying if at least one of the ground engaging teeth is missing based on the comparison The method includes providing a notification of the missing ground engaging teeth based on the identification.

### TECHNICAL FIELD

The present disclosure relates to a path detection system, and more particularly to a system and method for path detection of ground engaging teeth of a machine implement.

### BACKGROUND

Machines, for example, a wheel loader, include an implement to perform a variety of tasks on a worksite. This implement may be embodied as a bucket for digging, collecting, and dumping material from one location to another at the worksite. The bucket may include ground engaging teeth provided at an edge of the bucket that contacts the ground. The ground engaging teeth are used to dig into and/or lift the material off the ground.

However, sometimes during operation, the ground engaging teeth may loosen due to usage. Further, the loose around engaging teeth may fall off the implement. Sometimes, these ground engaging teeth may mix with the material being loaded into a crusher. In such a situation, there may be chances of the crusher getting damaged if such stray ground engaging teeth are present in the material entering the crusher. This may result in high machine downtime, increased service and maintenance time, and high operational costs.

Image data from an image feed of the ground engaging teeth may be analyzed using computer vision algorithms to detect the ground engaging teeth during a dump operation. Accordingly, on-board cameras pointed at the ground engaging teeth may be provided as input to the computer vision algorithms to assess the number of the ground engaging teeth present on the bucket. However, such systems may generate false positives, inaccurately tracking the ground engaging teeth using complex methods that may not be robust and effective.

United States Published Application Number 2015/0149049 describes a process and tool for monitoring the status, health, and performance of wear parts used on earth working equipment. The process and tool allow the operator to optimize the performance of the earth working equipment. The tool has a clear line of site to the wear parts during use and may be integrated with a bucket or blade on the earth working equipment.

### SUMMARY OF THE DISCLOSURE

In one aspect of the present disclosure, a method for path detection associated with ground engaging teeth of an implement is provided. The method includes receiving, by a controller, an image feed of a dump operation being performed by the implement from an image capturing device. The image feed includes a plurality of frames. The method includes detecting, by the controller, the ground engaging teeth in each of the plurality of frames of the image feed by iteratively scanning a plurality of sections of each of the plurality of frames. The method includes analyzing, by the controller, a path traced by the ground engaging teeth over the plurality of frames, such that path information associated with the ground engaging teeth is any one of aggregated or discarded based on a movement of the ground engaging teeth over the plurality of frames. The method includes determining, by the controller, the path traced by the ground engaging teeth based on the aggregated path information. The method includes comparing, by the controller, the determined path traced by the ground engaging teeth with a pre-determined path. The method includes identifying, by the controller, if at least one of the ground engaging teeth is missing based on the comparison. The method includes providing, by the controller, a notification of the missing ground engaging teeth based on the identification.

Other features and aspects of this disclosure will be apparent from the following description and the accompanying drawings.

### BRIEF DESCRIPTION OF THE DRAWINGS

FIG. 1 is a perspective view of an exemplary machine, according to various concepts of the present disclosure;

FIG. 2 is a block diagram of a path detection system associated with the machine of FIG. 1, according to various concepts of the present disclosure;

FIG. 3 is an exemplary image feed showing execution of processing steps being performed by the path detection system of FIG. 2, according to various concepts of the present disclosure;

FIG. 4 is an exemplary path associated with ground engaging teeth of the machine of FIG. 1 as detected by the path detection system, according to various concepts of the present disclosure; and

FIG. 5 is a flowchart of a method of operation of the path detection system, according to various concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

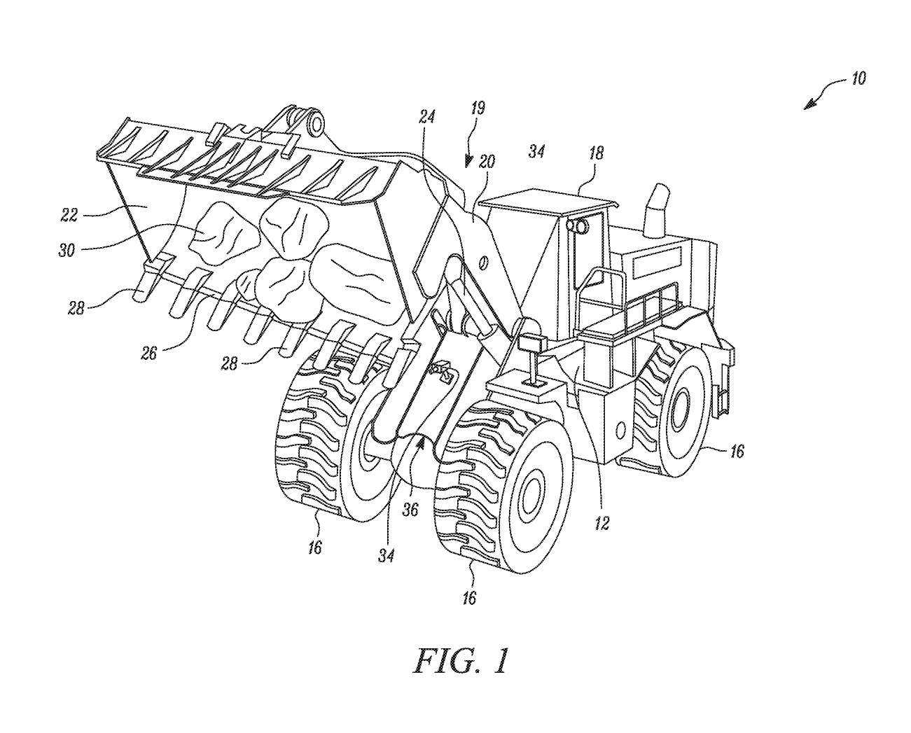

FIG. 1 represents an exemplary machine 10, according to one embodiment of the present disclosure. More specifically, the machine 10 is embodied as a wheel loader. Alternatively, the machine 10 may include any other earthmoving machine such as a motor grader, an excavator, a wheel tractor scarper, etc. that includes a bucket or blade having ground engaging teeth.

Referring to FIG. 1, the machine 10 includes a frame 12. A powertrain and/or a drivetrain (not shown) is also provided on the machine 10 for the production and transmission of motive power. The powertrain includes a power source (not shown) and is located within an enclosure of the machine 10. The power source may include one or more engines or other power delivery systems such as batteries, hybrid engines, and the like.

The machine 10 also includes wheels 16 for the purpose of mobility. The powertrain may also include a torque converter, a transmission system inclusive of gearing, a drive shaft and other known drive links provided between the power source and the wheels 16 for the transmission of the motive power. Further, the machine 10 has an operator cabin 18 that houses controls for operating the machine 10.

As shown in FIG, 1, a linkage assembly 19 is attached to the frame 12 of the machine 10. The linkage assembly 19 includes a lift arm 20. An implement, such as a bucket 22, is pivotally coupled to the lift arm 20. It may be noted that the linkage assembly 19 and the implement of the machine 10 may vary based on the type of machine 10 or the type of operation or task required to be carried out by the machine 10.

During operation of the machine 10, the lift arm 20 and the bucket 22 may be moved to different positions in order to perform excavation and dumping tasks. The movement of the lift arm 20 and/or the bucket 22 is controlled by hydraulic and/or pneumatic cylinders 24, which are coupled to these parts. Accordingly, based on the movement of the lift arm 20 and the bucket 22, the machine 10 may perform different operations such as excavating, loading, and dumping.

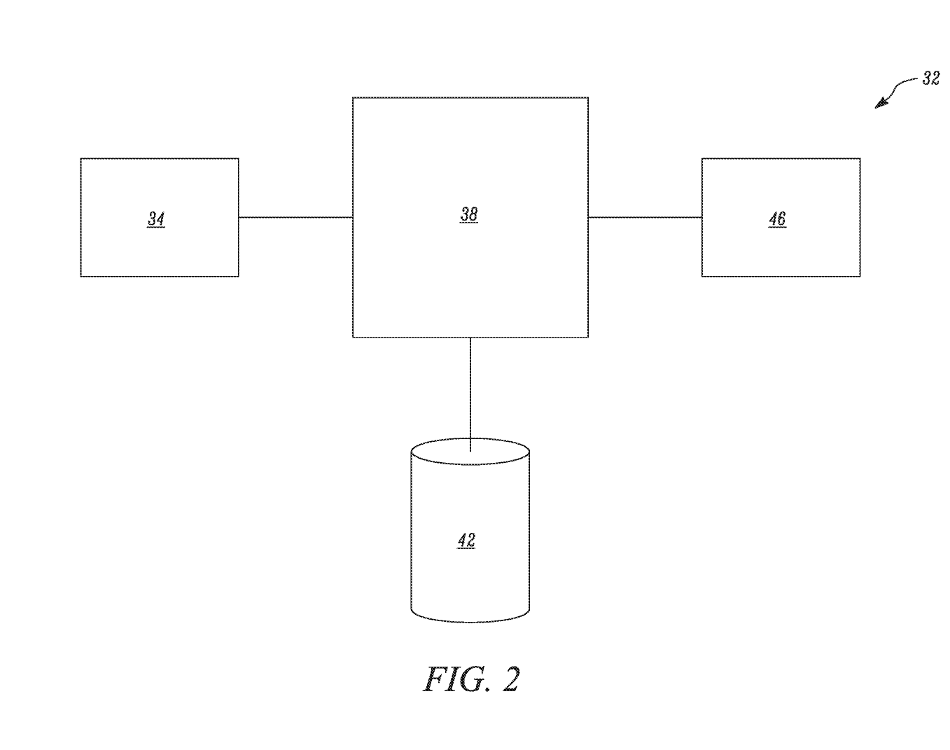

An edge 26 of the bucket 22 that contacts a ground surface includes ground engaging teeth 28 provided thereon. The ground engaging teeth 28 extend outwards from the edge 26. The ground engaging teeth 28 may be used to dig into and/or scrape the ground surface to lift off a material 30. The ground engaging teeth 28 may minimize wear on the edge 26 of the bucket 22 so that the easily replaceable ground engaging teeth 28 may be re-welded whenever required, thereby increasing the life of the bucket 22. The present disclosure relates to a path detection system 32 (see FIG. 2) associated with the ground engaging teeth 28.

Referring to FIGS. 1 and 2, the path detection system 32 includes an image capturing device 34. The image capturing device 34 may include any known imaging or video device, for example, a camera, a camcorder, or any other known device for capturing image or image feed. The image capturing device 34 is positioned on a front portion 36 (see FIG. 1) of the frame 12 of the machine 10. The image capturing device 34 is focused at the edge 26 of the bucket 22 to capture the image feed of an underside of the bucket 22, while a dump operation is being performed. More specifically, the image capturing device 34 captures the image feed of a movement of the bucket 22 along with the ground engaging teeth 28, as the material 30 is being lifted and dumped by the bucket 22 of the machine 10. Alternatively, the image capturing device 34 may be positioned at any other location on the machine 10 to obtain an unobstructed view of the ground engaging teeth 28.

Referring to FIG. 2, the image capturing device 34 is communicably coupled to a controller 38. The controller 38 receives the image feed of the dump operation, as the bucket 22 is lowered from a raised position after a dumping operation. The image teed includes a number of frames of images of the underside of the bucket 22, showing the movement of the bucket 22, the ground engaging teeth 28, and the material 30 falling off from the bucket 22 captured over a predefined time period.

The controller 38 analyses the image feed on a frame by frame basis. The controller 38 makes use of an algorithm to assess each of the frames of the image feed. The controller 38 detects a presence of the ground engaging teeth 28 in the image teed. In one embodiment, the algorithm may be a machine learning algorithm. For example, a support vector machine using a histogram of oriented gradients as a feature vector may be utilized to perform the detection.

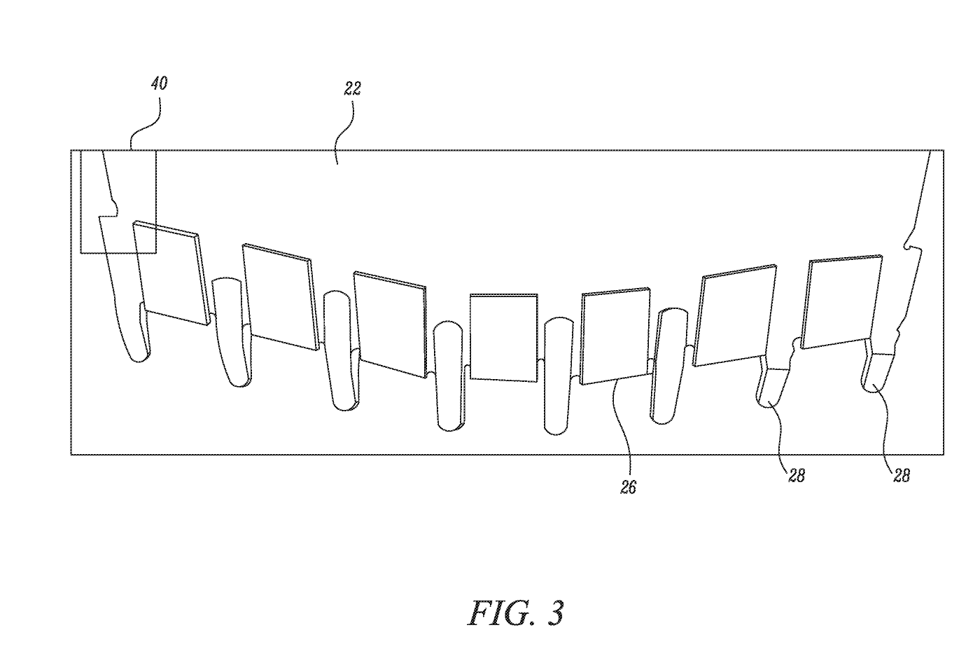

Using the machine learning algorithm, the controller 38 may iteratively scan multiple adjacent sections or areas of each frame. In other words, as shown in FIG. 3, a sliding window 40 may be iteratively moved across the frame from right to left and top to bottom of the frame to scan the entire frame for detecting the presence of the ground engaging teeth 28. Alternatively, a movement of the sliding window 40 may follow any other path without any limitation for scanning the entire frame. Dimensions of the sliding window 40 may be predefined and may vary based on the application.

A training dataset, which is aggregated or built for the purposes of training machine learning, may include large volumes of representative training data for detecting the presence of the ground engaging teeth 28. The training data may be divided into positive training set images and negative training set images. The positive training set images may include clean images, dirty images, and augmented images for example translated images, rotated images, and/or mirror images. The algorithm applies the trained support vector machine classifier to multiple frames of the image feed, such that the sliding window 40 iteratively progresses along the sections of the frame and derives the histogram of oriented gradient features. In one example, the training data may be stored in a database 42 (see FIG. 2) which is communicably coupled to the controller 38. The database 42 may be any known data storage or memory device for storing and retrieving data templates associated with the around engaging teeth 28. Alternatively, the training data may be stored at a remote location, in a cloud, an external repository or any other combination thereof.

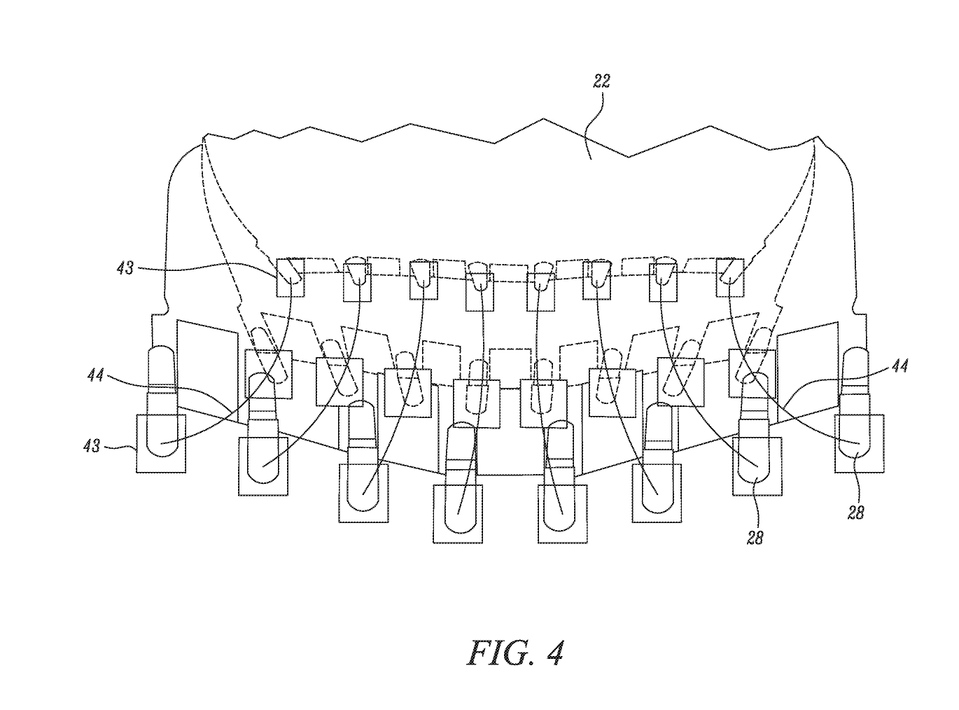

Further, the controller 38 may detect the presence of the ground engaging teeth 28 in each frame of the image feed by performing a raw detection of the ground engaging teeth 28 from the sliding window 40 detector and then cleaning the detection made, for example by using RANSAC. The controller 38 pools overlapping detections and further finds a highest scoring window inside each pooled location denoted by representative boxes 43 shown in FIG. 4.

After detection of the ground engaging teeth 28, the controller 38 analyses a path traced by the ground engaging teeth 28 as the bucket 22 moves from one position to another over each of the frames of the image feed. Referring to FIG. 4, during the dump operation, each of the around engaging teeth 28 traces a path similar to that of an arc on an image plane of the image capturing device 34.

The controller 38 uses an algorithm to analyze the path traced by each of the around engaging teeth 28 over different frames of the image feed. By accumulating and analyzing the detections of the ground engaging teeth 28 over multiple frames throughout each of the dump operations, the controller 38 may algorithmically ascertain the path traced by the ground engaging teeth 28, developing a higher confidence in the number of the ground engaging teeth 28 present on the bucket 22 as the dump operation progresses. The path traced is expected to be a curved path 44. As shown in the accompanying figures, each of the eight ground engaging teeth 28 traces the curved path 44 over the multiple frames of the image feed. However, the path may vary based on the positioning of the image capturing device 34 on the machine 10.

More particularly, the algorithm for analyzing the path traced by each of the ground engaging teeth 28 may make use of a spatial-temporal trajectory filter that is applied by the controller 38 over the multiple frames of the image feed. After detecting the ground engaging teeth 28 in a given frame ‘n’, the controller 38 searches subsequent frames, say frame ‘n+1’ and frame ‘n+2’ for the closest detection of the presence of the ground engaging teeth 28 within a predetermined distance, for example approximately 100 pixels. If such detection is found by the controller 38, the controller 38 aggregates path information of the detection of the ground engaging teeth 28 that lie within the predetermined distance to that of an existing path. This existing path information is associated with the path traced by the given ground engaging teeth 28, in line with the movement of the ground engaging teeth 28 over the multiple frames of the image feed. Alternatively, if the ground engaging teeth 28 are detected outside of the predetermined distance in the subsequent frames, the controller 38 discards or rejects the path information of the given ground engaging teeth 28.

Accordingly, based on the aggregated path information of each of the ground engaging teeth 28 over the multiple frames of the image feed, the controller 38 determines the path that is traced by the ground engaging teeth 28 during the dump operation. It should be noted that the path information must be analyzed over multiple consecutive frames. The steps of path estimation described herein make use of simple filter settings. These steps are included on an exemplary basis and do not limit the scope of the present disclosure.

The controller 38 may then determine the path traced by the around engaging teeth 28 over the multiple frames based on the aggregated path information associated with each of the ground engaging teeth 28. As shown in FIG. 2, the controller 38 is communicably coupled to an output device 46. The output device 46 may include any known visual device for example, a monitor, a touchscreen, and so on. In one embodiment, the controller 38 may provide a command to the output device 46 to provide an output of the detected path traced by the around engaging teeth 28 on the output device 46 in the form of a graph or any other suitable representation.

The controller 38 may additionally compare the path traced by each of the ground engaging teeth 28 with a predetermined path. For example, the predetermined path may be a previous instance of the path recorded. In one embodiment, the predetermined path may be retrieved from the database 42. Based on the comparison, the controller 38 identifies if one or more of the around engaging teeth 28 were either lost or distorted during the dump operation. For example, the controller 38 may count a number of the paths traced by the ground engaging teeth 28 to check if any of the ground engaging teeth 28 are missing. Alternatively, any other type of comparison may be used to identify if one or more of the ground engaging teeth 28 were lost during the dump operation.

If the controller 38 identifies that at least one of the ground engaging teeth 28 are missing, the controller 38 may send a command signal to the output device 46 to provide a notification to an operator. The output device 46 may optionally include any known visual and/or auditory device such as, a speaker, a screen, an alarm, a light emitting diode, and so on to provide the notification to the operator. The analyses performed by the controller 38 and/or the output provided by the controller 38 may be provided on a relatively close to real-time basis, factoring in a slight delay that is attributed to data capture associated with the subsequent frames of the image feed. Accordingly, if time taken to capture the subsequent data frames is defined by the predefined time period, for example approximately between 3 and 5 seconds, the delay in providing the output by the controller 38 may be appropriately defined on the basis of the predefined time period.

The controller 38 may embody a single microprocessor or multiple microprocessors. Numerous commercially available microprocessors can be configured to perform the functions of the controller 38. The controller 38 may include all the components required to run an application such as, for example, a memory, a secondary storage device, and a processor, such as a central processing unit or any other means known in the art. Various other known circuits may be associated with the controller 38, including power supply circuitry, signal-conditioning circuitry, solenoid driver circuitry, communication circuitry, and other appropriate circuitry.

### INDUSTRIAL APPLICABILITY

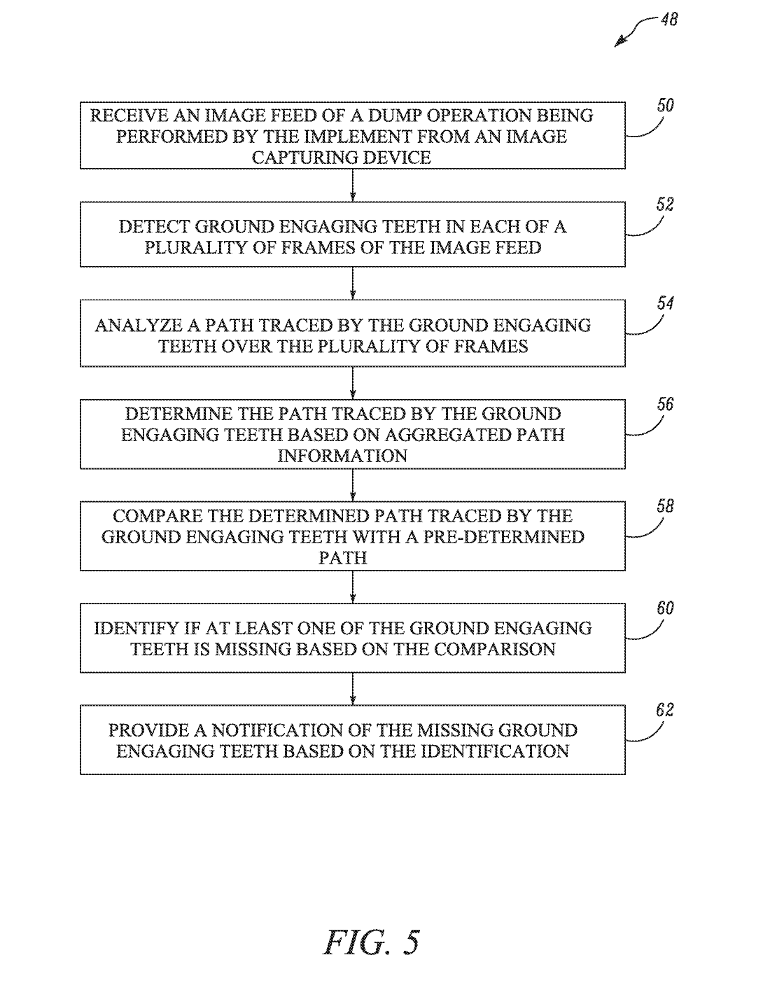

The present disclosure relates to the system and method for path detection of the ground engaging teeth 28 associated with the implement of the machine 10. FIG. 5 is flowchart of a method 48 of operation of the path detection system 32. At step 50, the controller 38 receives the image feed of the dump operation being performed by the implement from the image capturing device 34. At step 52, the controller 38 detects the ground engaging teeth 28 in each of the multiple frames of the image feed. The controller 38 iteratively scans multiple sections of each of the frames by sliding the window 40 over the frames for detecting the ground engaging teeth 28. At step 54, the controller 38 analyses the path traced by the ground engaging teeth 28 over the successive frames. The controller 38 either aggregates the path information associated with the given ground engaging teeth 28 over the successive frames or discards the path information based on the movement of the ground engaging teeth 28 over the successive frames. At step 56, the controller 38 determines the path traced by each of the ground engaging teeth 28 of the bucket 22 based on the aggregated path information obtained over the multiple frames.

Further, at step 58 the controller 38 compares the determined path traced by the ground engaging teeth 28 with the pre-determined path. At step 60, based on the comparison the controller 38 identifies if one or more of the ground engaging teeth 28 are missing. At step 62, the controller 38 provides the notification of the missing ground engaging teeth 28 if such ground engaging teeth 28 are identified.

The present disclosure provides a simple and cost effective solution that can be implemented easily for detecting the path traced by the ground engaging teeth 28. The system also notifies the operator if any of the ground engaging teeth 28 were lost during the dump operation so that corrective actions may be taken before the material 30 is introduced into the crusher. Further, the system may greatly reduce a number of false positives in the identification and detection of the presence of the ground engaging teeth 28 in the image feed.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for path detection associated with ground engaging teeth of an implement, the method comprising:
receiving, by a controller, an image feed of a dump operation being performed by the implement from an image capturing device, wherein the image feed includes a plurality of frames;
detecting, by the controller, the ground engaging teeth in each of the plurality of frames of the image feed by iteratively scanning a plurality of sections of each of the plurality of frames;
analyzing, by the controller, a path traced by the ground engaging teeth over the plurality of frames, such that path information associated with the ground engaging teeth is any one of aggregated or discarded based on a movement of the ground engaging teeth over the plurality of frames;
determining, by the controller, the path traced by the ground engaging teeth based on the aggregated path information;
comparing, by the controller, the determined path traced by the around engaging teeth with a pre-determined path;
identifying, by the controller, if at least one of the ground engaging teeth is missing based on the comparison; and
providing, by the controller, a notification of the missing around engaging teeth based on the identification.
